(19) United States
(12) Patent Application Publication
(10) Pub. No.: US 2001/0055069 A1
(43) Pub. Date: Dec. 27, 2001

(54) One camera system for component to substrate registration

(76) Inventor: Edison T. Hudson, Chapel Hill, NC (US)

Correspondence Address: David B. Ritchie, THELEN REID & PRIEST LLP, P.O. Box 640640, San Jose, CA, 95164-0640, US

(21) Appl. No.: 09/803,495

(22) Filed: Mar. 8, 2001

Related U.S. Application Data
(60) Provisional application No. 60/188,579, filed on Mar. 10, 2000.

(51) Int. Cl. H04N 3/14

(52) U.S. Cl. 348/302; 348/207

(57) ABSTRACT

A machine vision camera observes components to be placed at a selected location on a substrate from a given angle relative to the orthogonal to the substrate through a mirror and then observes the selected location on the substrate from the same angle but with the mirror displaced in order to measure, register and align under-side contact and edge features of the component to corresponding substrate features. The camera moves with the pick-up head of a placement machine that picks up the component from a component feeder or component store and transports it to a location above a mirror where its bottom surface and edges are imaged as it is held stationary. The mirror may be carried with the pick-up head and may be retractable. Component feature coordinate locations are calculated and used to calculate the coordinates of the component features relative to the pick-up head. The selected location of the substrate is imaged by the same camera but with the intervening mirror displaced and coordinates for features corresponding to those of the component features are obtained in a similar fashion. A difference vector is then calculated to determine how the pick-up head should be moved (excluding the Z- or vertical direction) so that the corresponding component and target substrate features are brought into physical contact. Additionally, an iterative alignment of component to substrate significantly improves alignment accuracy beyond the dead reckoning accuracy of the placement machine's mechanics. Finally, the component is moved in the Z-direction to bring it into contact with the substrate.

### RELATED APPLICATIONS

This application claims the benefit of provisional U.S. patent application Ser. No. 60/188,579 filed on Mar. 10, 2000 in the name of Edison T. Hudson and commonly assigned herewith.

### FIELD OF THE INVENTION

The present invention relates to machine control systems utilizing machine vision systems for relative positioning of a component and a substrate for accurate placement of the component at a selected location on the substrate. More particularly, the present invention is directed to a method for employing a single electronic imager to facilitate accurate alignment and registration of components to substrate features. While the specific examples discussed herein relate largely to the electronics assembly industry, the components placed may be electronic, electro-optic, electro-mechanical, optical, mechanical, micro-electronic machine (MEMS) devices, biological material, and the like, and may be of any size.

### BACKGROUND OF THE INVENTION

Robotic assembly equipment is well known in the art. Such equipment includes, for example, pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts or “reflows” forming permanent electrical connections between conductive pads on the PCB and electrical contacts, leads or “pins” on the electrical components.

Occasionally there are problems with the permanent electrical connections. For example, two pads of the PCB may become inadvertently bridged by solder, forming a short; the component may be mis-located; the component may prove faulty; and the like. In these situations, it is often economically desirable to salvage the partially assembled PCB rather than to scrap it. In order to salvage the PCB, one must remove the faulty component, re-prepare the PCB surface, and place and solder a new component (or a cleaned component) in the correct position on the PCB. This process is termed “rework”. Reworking thus involves reflowing the solder of an identified target component (and not that of the entire PCB), removing the faulty component; cleaning and refluxing the PCB in the location where the component is to be mounted, reinstalling the component and reflowing the solder for the component.

In the past, most known rework systems operate almost entirely manually, i.e., a skilled operator, using an optical magnification system which views both the PCB top surface and the component bottom surface, manually aligns the PCB and the component for placement. Placement systems, on the other hand, typically employ machine vision systems to automate this process. However, most known systems utilize a pair of imagers. One imager views the top surface of the PCB to obtain PCB alignment information by imaging known reference points on the PCB (known in the art as “fiducials”) and/or by imaging contact pads on the PCB, another imager views the component, its bottom and/or its sides, to determine component alignment information. Since such machine vision imagers are relatively expensive, it would be desirable to employ a single machine vision imager to capture all images necessary to provide automated placement and rework capabilities to placement and rework equipment.

### BRIEF DESCRIPTION OF THE INVENTION

A machine vision camera observes components to be placed at a selected location on a substrate from a given angle relative to the orthogonal to the substrate through a mirror and then observes the selected location on the substrate from the same angle but with the mirror displaced in order to measure, register and align under-side contact and edge features of the component to corresponding substrate features. The camera moves with the pick-up head of a placement machine that picks up the component from a component feeder or component store and transports it to a location above a mirror where its bottom surface and edges are imaged as it is held stationary. The mirror may be carried with the pick-up head and may be retractable. Component feature coordinate locations are calculated and used to calculate the coordinates of the component features relative to the pick-up head. The selected location of the substrate is imaged by the same camera but with the intervening mirror displaced and coordinates for features corresponding to those of the component features are obtained in a similar fashion. A difference vector is then calculated to determine how the pick-up head should be moved (excluding the Z- or vertical direction) so that the corresponding component and target substrate features are brought into physical contact. Additionally, an iterative alignment of component to substrate significantly improves alignment accuracy beyond the dead reckoning accuracy of the placement machine's mechanics. Finally, the component is moved in the Z-direction to bring it into contact with the substrate.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a system block diagram of an X, Y, Z, T positioning system in accordance with the prior art.

FIG. 2 is a schematic diagram of a Z/T positioning stage of an X, Y, Z, T positioning system in accordance with the prior art.

FIG. 3 is a system block diagram of a computer control system for an X, Y, Z, T positioning system in accordance with the prior art.

FIG. 4 is a block diagram illustrating a single camera system which uses a mirror for component registration in accordance with a specific embodiment of the present invention.

FIG. 5 is a block diagram illustrating a single camera system as in FIG. 4 but with the mirror displaced for substrate registration in accordance with a specific embodiment of the present invention.

FIG. 6 is a system block diagram of a computer control system for an X, Y, Z, T positioning system in accordance with the prior art.

FIG. 7 is a block diagram illustrating a single camera system which uses a mirror for component registration indicating the focal distance from the single camera to the center of the underside of the component in accordance with a specific embodiment of the present invention.

FIG. 8 is a block diagram illustrating a single camera system indicating the focal distance from the single camera to the center of the target location on the target substrate in accordance with a specific embodiment of the present invention.

FIG. 9 is a ray diagram illustrating the varying lengths of the optical paths caused by the tilt of the single camera in a single camera system in accordance with a specific embodiment of the present invention.

FIG. 10 is a diagram illustrating a calibration target for spatial factors used for digital image processing to correct parallax and perspective image error in a single camera system in accordance with a specific embodiment of the present invention.

FIG. 11 is a block diagram illustrating a single camera system which uses an angled laser spot generator as a Z-height calibrator in accordance with a specific embodiment of the present invention.

FIG. 12 is a block diagram of a single camera system employing a retractable mirror carried with the pick-up head.

### DETAILED DESCRIPTION

Embodiments of the present invention are described herein in the context of a one camera system for component to substrate registration. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, certain components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the automation industry robots are widely used to perform processes on components. Any type of robot can be used with the present invention. For example, a single linear axis robot, a Scara robot and a Cartesian X/Y system may all be used, as can other systems designed to position a component relative to a substrate with a given positional accuracy.

In most cases, a robot is equipped with a Z-axis, carrying a tool. Often the tool may be rotated about the Z-axis in the T direction which is normally specified by an angle. At the tool various nozzles or grippers can be mounted to perform processes on attached components. The invention, by way of example and not limitation, can be used in the: electronics industry for SMT (surface mount technology) placement and repair, component assembly, printed circuit board (PCB) assembly, test and reflow; semiconductor industry for chip assembly including flip chip, micro-BGA (ball grid array) and balling; optics/photonics industry for micro-optics assembly, optics handling, optical elements packaging; mechanics industry for micro-assembly, material handling and component packaging; biotechnology industry for pharmaceutical production, liquid handling applications, genetic screening, assay handling and research applications.

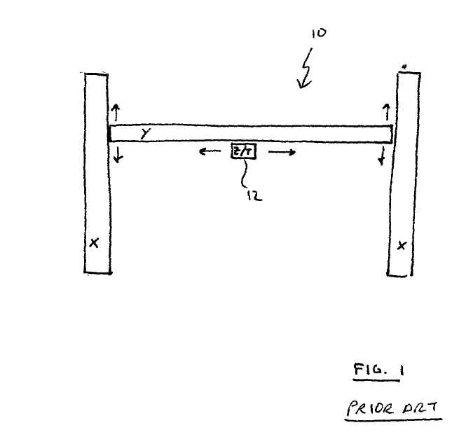

Turning now to FIG. 1, a system block diagram of a placement machine 10 is illustrated. The placement machine 10 positions a Z/T stage 12 in the X and Y (horizontal) directions by moving the Z/T stage 12 along positional axis Y and moving positional axis Y between rails X which define the X-axis. Such systems are well known to those of ordinary skill in the art and can be built to various positional resolution accuracies, that is, if one wants to position a particularly sized object held by the Z/T stage to within a given range of distance, say +/−20 microns, those of ordinary skill in the art know how to build such systems.

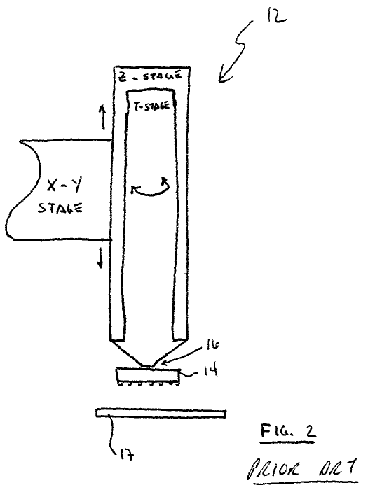

Turning now to FIG. 2, a schematic diagram of a Z/T positioning stage 12 of an X, Y, Z, T positioning system in accordance with the prior art is shown. The Z/T positioning stage holds a component 14 with a gripper 16 which can be a mechanical gripper, a vacuum gripper nozzle, or the like. The Z-stage includes a motor or actuator to position the stage along the vertical axis and over the substrate 17. The T-stage includes a motor or actuator to rotationally position the component. Thus, the X-Y stages position a component over a selected location of a substrate, the T-stage adjusts the orientation of the component for rotational position, and the Z-stage allows the component to be raised and lowered and, ultimately allows the component to be It placed down on the substrate at a position within the positional resolution accuracy of the X-Y stage. Such systems, as discussed before, are well within the skill of those of ordinary skill in the art.

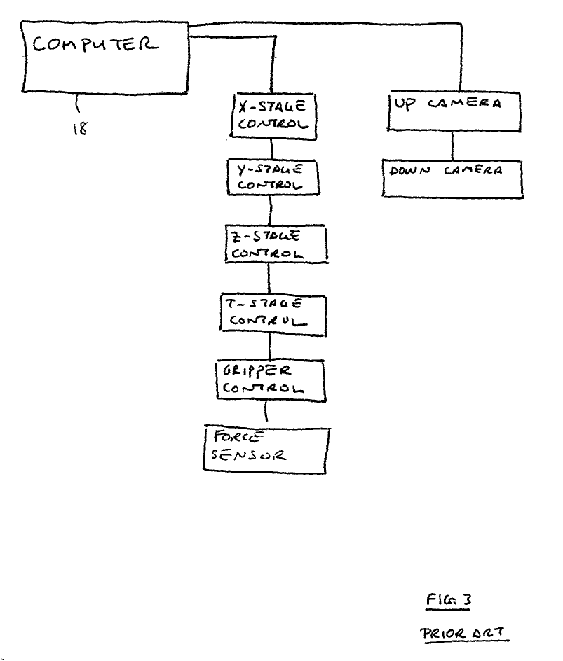

Turning now to FIG. 3, a system block diagram of a computer control system for an X, Y, Z, T positioning system in accordance with the prior art is shown. Such systems include a computer 18 that may be of any suitable type, such as a microprocessor, digital signal processor, and the like. Computer 18 may be distributed among several locations or located at a central site. Computer 18 receives inputs from position detectors associated with the various stages and provides outputs to actuators controlling the various stages. It also controls the component pickup gripper and reads an output from a force sensor, if present, to determine the amount of force being applied to the pick-up head in compression against the substrate. Computer 18 (or a separate system in communication with computer 18) also reads inputs from one or more machine vision system cameras (or similar devices) that image the component and the substrate to assist in accurate placement of a component to the substrate. Generally such systems include a camera mounted on the bed of the placement machine having its associated optics oriented so as to look up at the bottom surface or a side of the component and thereby determine its X, Y and T orientation. Such systems also usually have a camera mounted with the pick-up head on the Z/T stage that can image the substrate from the pick-up head and determine its relative location. Such machine vision systems are commercially available and are all well within the skill of those having ordinary skill in the art.

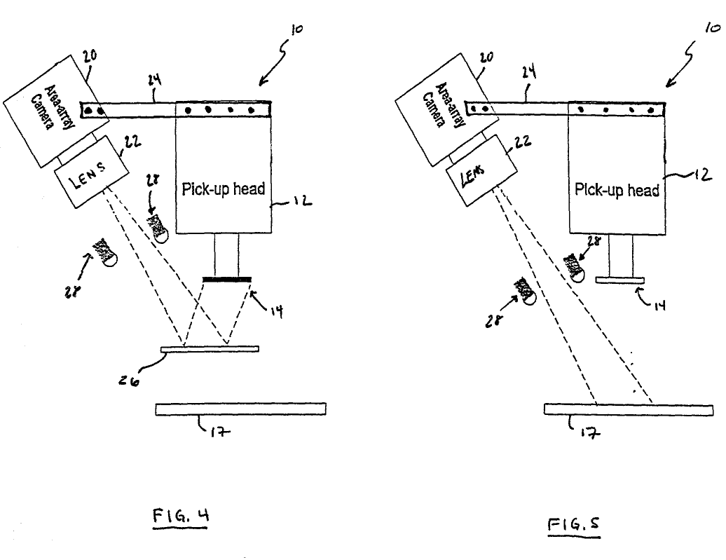

FIG. 4 is a block diagram illustrating a single camera system which uses a mirror for component registration in accordance with a specific embodiment of the present invention and FIG. 5 is a block diagram illustrating a single camera system as in FIG. 4 but with the mirror displaced during substrate registration in accordance with a specific embodiment of the present invention.

Turning now to FIGS. 4 and 5, a camera 20 which includes a lens 22 is mounted on an arm 24 of a placement machine 10 so that it moves with the Z/T stage 12. Camera 20 is preferably an array-type area scanning camera, such as a charge coupled device (CCD) camera or a CMOS camera which is scanned electronically, but the invention is not intended to be so limited and is meant to encompass other camera implementations such as a conventional linear array camera which is scanned mechanically or a vidicon-type camera and the like. Component pick-up head 12, mounted to the X-Y motion system of the placement machine 10 is thereby capable of motion in the horizontal X-Y plane as well as motion in the vertical Z direction and in rotation about the Z-axis (T). Camera 20 is mounted at an angle to the vertical (an angle to the orthogonal to the substrate) as shown which permits direct observation and imaging of substrate 17 and indirect observation and imaging of a component 14 being held by the pick-up head 12 through a single front silvered mirror 26 retractably mounted in a horizontal plane disposed between the substrate 17 and the component 14 held by pick-up head 12. Mirror 26 reflects an underside image of component 14 back to camera 20. A line down the boresight of the camera preferably intersects a line orthogonal to the substrate at an angle of between about 15 and about 35 degrees from the vertical as shown. Camera 20 should preferably be oriented so that its field of view contains the center-line of pick-up head 12 holding component 14 at the point where component 14 intersects a selected target location on substrate 17 in addition to permitting camera 20 to observe the underside and edges of the component 14 using the mirror 26.

Pick-up head 12 of placement machine 10 moves in the X, Y, Z and T directions to pick up a stored component and transport it to a location above the substrate 17. While the component 14 is held in place over the substrate 17 with mirror 26 disposed between component 14 and substrate 17 and is preferably illuminated by directed lighting 28, camera 20 images component 14's bottom surface and edges capturing a digital image transmitted to the machine vision system of computer 18. Coordinate locations are calculated in a conventional manner by the machine vision system implemented on computer 18 for relevant component features such as connection bumps on a flip chip. These coordinate locations are used to further determine the X, Y and T coordinates of these component features relative to the pick-up head 12. The target substrate 17 is also imaged by camera 20 but without the intervening mirror 26 and coordinates for features corresponding to those of the component features are determined. A difference vector is then calculated to determine how the pick-up head should be moved (except in the Z-direction) to bring it to a position directly over the selected location on the substrate. The pick-up head 12 holding the component 14 is then moved in X, Y and T directions, transporting the component 14 to a location which reduces the offset coordinate values to zero (except in Z) and thus when lowered in Z brings the component 14 and substrate 17 into physical contact at the selected location on the substrate 17.

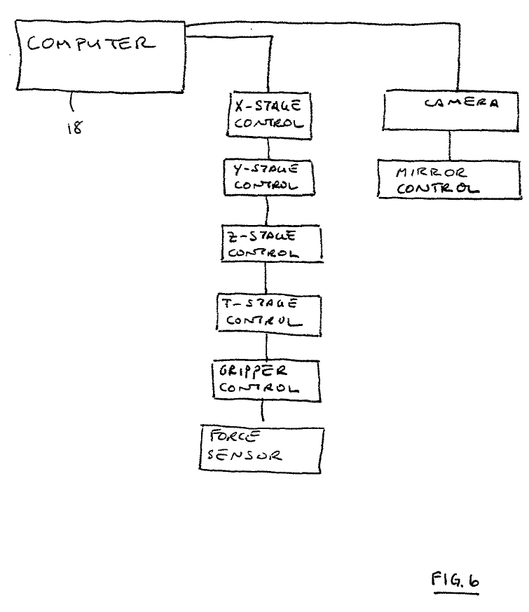

In order to accommodate these different operations, the connection diagram of FIG. 3 is modified to that of FIG. 6 to provide for control of the moveable mirror 26 and the fact that there is only a single camera for providing imagery to the computer 18.

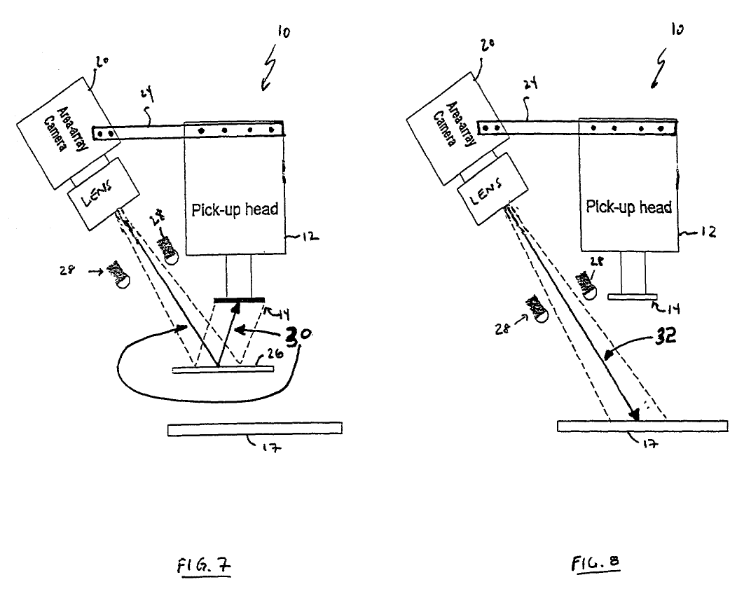

FIG. 7 is a block diagram illustrating a one camera system which uses a mirror for component registration indicating the focal distance from the single camera to the center of the underside of the component in accordance with a specific embodiment of the present invention. FIG. 8 is a block diagram illustrating a single camera system indicating the focal distance from the single camera to the center of the target location on the target substrate in accordance with a specific embodiment of the present invention.

Referring now to FIGS. 7 and 8, the focal distance 30 to the center of the underside of the component 14 seen by using the mirror 26 and the focal distance 32 from the single camera 20 to the center of the selected location on the target substrate 17 respectively, are made approximately equal for any given field of view. In this way the images of the component 14 and selected location on target substrate 17 are on the same dimensional scale which improves the accuracy of correspondence between them.

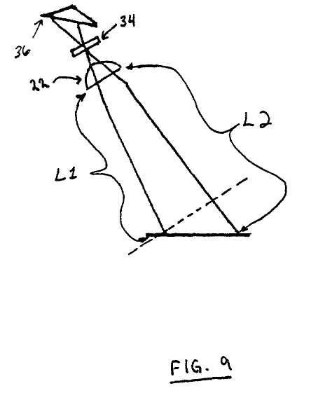

However, there are optical distortion errors introduced by the tilt of camera 20 which must be corrected. The errors are due to the varying lengths of the optical paths caused by the tilt of camera 20 as illustrated in FIG. 9 by length L1 and length L2. For images of component 14 captured as illustrated in FIG. 4, it is first of all necessary to completely flip the image of component 14 to compensate for the reversing effect of the mirror 26. This is easily performed with any conventional commercially available machine vision system. In addition, various optical methods can be used alone or in combination to correct for the effects of the tilt of camera 20. For example, as illustrated in FIG. 9, including an additional optical path component 34 between the camera lens 22 and the camera focal plane 36 can create a sheinflug angle which compensates for the tilt angle in the images of component 14 and target substrate 17 by applying a corresponding reverse distortion prior to the image being captured by camera 20.

A wavefront coding system provides an alternative means for correcting for the focus distortion caused by the tilted angle of the single camera 20. Such wavefront coding systems are available from CDM Optics, Inc., Boulder, Colorado. Wavefront coding includes disposing an optical convolving lens element between the focal plane of the camera and the conventional camera optics and using a computer-implemented algorithm for deconvolving the image so as to increase the depth of field so that all parts of the image are in focus despite the differences in focal length across the image introduced by the tilt of camera 20. The addition of the optical convolving lens element results in images with a specialized well defined blur or point spread function that is insensitive to misfocus. The algorithm applied to the sampled image produces a sharp and clear image that is insensitive to misfocus effects such as those introduced by the tilt angle of camera 20. The wavefront coding system can produce up to a ten-fold increase in depth of field and reduces other focus-related aberrations. Such systems are commercially available and are well within the skill of those of ordinary skill in the art.

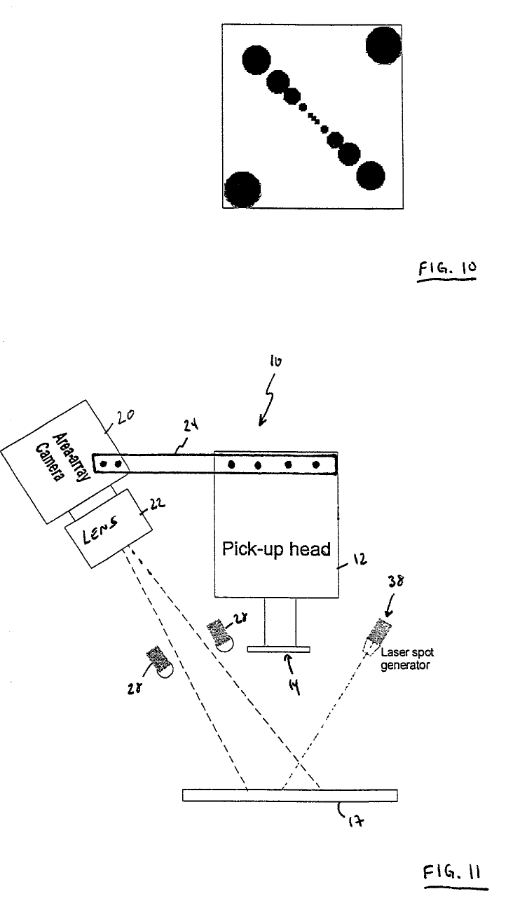

Further digital processing to correct parallax and perspective error must generally also be applied to the image to obtain accurate component feature measurement and registration. Perspective distortion variables are corrected using a set of parameter and geometric algorithms determined by observing a lithographically produced high accuracy calibration target such as that shown in FIG. 10. Parallax error is corrected using a highly accurate 3 dimensional target or a combined target similar to the calibration target for spatial factors shown in FIG. 10. The values determined for these spatial factors are ascertained once for a given physical set-up and stored and are then applied to each new image that is analyzed by the system. This approach is also well known to those of ordinary skill in the art.

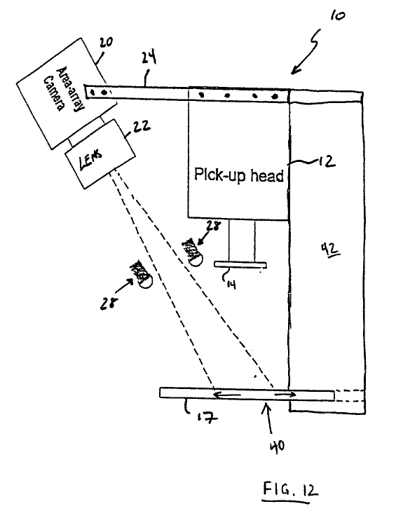

The single camera system of the present invention also accounts for variations in the thickness of a component 14 and variations in the height of a target substrate 17. The system is calibrated for such variations with a Z-height calibrator comprising any number of tools that are well known to those of ordinary skill in the art. For example, such a calibration to account for Z-height variations may be achieved by using a contact sensor which uses either a force or displacement sensor mounted with the pick-up head for accurately measuring the actual Z-position at which physical contact occurs between component 14 carried by the pick-up head and target substrate 17. This could be, for example, a force sensor disposed in the Z-stage as is well known to those of ordinary skill in the art. Another example of a Z-height calibrator is a laser point triangulation system as illustrated in FIG. 11 which uses a laser pointer 38 set at an angle relative to the field of view of camera 20. The laser pointer 38 projects a single point of light onto the field of view at a known and calibrated X-Y location and deviations in the point location from its known or calibrated location can be interpreted as height or thickness variations in the component 14 or target substrate 17 using conventional triangulation methods and the known angle of incidence of the laser pointer 38. Mechanical probing, non-contact probing and other standard tools of the trade can also be used for measuring the height of the component 14 or target substrate 17. Such probes would be mounted to the placement machine and moved to the target substrate 17 for determining substrate height, or in the case of the component 14, they would be mounted at a fixed station in an X-Y plane of the placement machine so that the thickness of the component 14 could be determined by carrying it to the fixed station for measurement.

FIG. 12 illustrates a block diagram of a single camera system employing a retractable mirror 40 which retracts into box 42 when the mirror is not needed.

An additional and significant feature of the single camera system of the present invention as illustrated generally in FIGS. 4 and 5 is the capability to provide improved accuracy in alignment between the component 14 and target substrate 17 beyond the absolute dead reckoning accuracy of the placement machine's mechanics. The improved alignment accuracy is achieved through an iterative method made possible by the tilted angle of camera 20 which provides a field of view containing the center line of the Z-axis at the point where the component 14 intersects the target substrate 17. As previously described, an offset vector is calculated between feature locations of component 14 and feature locations of target substrate 17 in directions other than the Z-direction based upon images captured by camera 20. The offset vector can be used to move the pick-up head 12 holding the component 14 in X, Y and T directions to a location which reduces the offset vector to zero and brings the corresponding component 14 and target substrate 17 features into vertical alignment. However, using this one time, dead reckoning motion of the pick-up head 12 to transport the component 14 to the selected location on the target substrate 17 can introduce alignment errors which are greater than the effective positional resolution accuracy of the placement machine. These alignment errors are corrected in accordance with the present invention by an iterative process which moves the pick-up head 12 in progressively smaller steps toward its desired location in X, Y and T space while calculating new offset vectors after each step based on new target substrate coordinates from the re-imaged target substrate 17. A new offset vector is calculated based on the re-imaged target substrate 17, and the pick-up head 12 again moves in only the X, Y and T directions. This process of movement and re-imaging of the target substrate 17 continues until the X, Y and T offset vector dimension values are less than a desired dimensional error value. The desired dimensional error value is a value for each dimension which is less than the positional resolution accuracy of said placement machine. After acceptable X, Y and T offset vector dimension values are achieved, the pick-up head 12 is moved in the Z (vertical) direction to reduce the last Z offset vector dimension to zero, thus bringing the corresponding component 14 and target substrate 14 features into physical contact. This iterative process results in a placement accuracy of the single camera system that is within the effective motion resolution of the placement machine.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A one camera system for component to substrate registration in a placement machine including at least an X-motion stage and a Z-motion stage including a pick-up head for carrying the component to a selected location on the substrate, said system comprising:
a camera mounted to move with the Z-motion stage along the X-motion direction, said camera directed to image a region below the Z-motion stage; and
a mirror mounted orthogonally to the Z-direction and positionable in a retracted position and an extended position, said mirror reflecting an image of the bottom of the component to the camera when the mirror is in the extended position and said mirror permitting the camera to image the substrate immediately below the component.

2. A system in accordance with claim 1, further comprising:
a computer vision system for capturing successive pairs of images of the bottom of the component and of the substrate from the camera.

3. A system in accordance with claim 2, further comprising:
a calculator iteratively calculating an offset vector from said successive pairs of said images and providing iterative control commands to move said pick-up head in at least said X-motion direction until said pick-up head is within a desired distance along at least the X-direction of the selected location on the substrate.

4. A system in accordance with claim 3, further comprising:
a Z-actuator for bringing the component into contact with the substrate.

5. A one camera system for component to substrate registration in a placement machine including an X-Y motion stage and a Z-motion stage including a pick-up head for carrying the component to a selected location on the substrate, the pick-up head being carried by the X-Y motion stage, said system comprising:
a camera mounted to move with the Z-motion stage over an X-Y plane, said camera directed to image a region below the Z-motion stage; and
a mirror mounted parallel to said X-Y plane, orthogonal to the Z-direction, below the pick-up head and positionable in a retracted position and an extended position, said mirror reflecting an image of the bottom of the component to the camera when the mirror is in the extended position and said mirror permitting the camera to image the substrate immediately below the component.

6. A system in accordance with claim 5, further comprising:
a computer vision system for capturing successive pairs of images of the bottom of the component and of the substrate from the camera.

7. A system in accordance with claim 6, further comprising:
a calculator iteratively calculating an offset vector from said successive pairs of said images and providing iterative control commands to move said pick-up head over said X-Y plane until said pick-up head is within a desired distance in the X-Y plane of the selected location on the substrate.

8. A system in accordance with claim 7, further comprising:
a Z-actuator for bringing the component into contact with the substrate.

9. A system in accordance with claim 4, further comprising a Z-height calibrator.

10. A system in accordance with claim 9, wherein said Z-height calibrator includes a laser spot generator.

11. A system in accordance with claim 9, wherein said Z-height calibrator includes a force sensor mounted along the Z-stage to detect component contact with the substrate.

12. A system in accordance with claim 8, further comprising a Z-height calibrator.

13. A system in accordance with claim 12, wherein said Z-height calibrator includes a laser spot generator.

14. A system in accordance with claim 12, wherein said Z-height calibrator includes a force sensor mounted along the Z-stage to detect component contact with the substrate.

15. A system in accordance with claim 4, further comprising a focus corrector correcting focus distortion in the images received by the camera.

16. A system in accordance with claim 15 wherein said focus corrector includes an optical path component.

17. A system in accordance with claim 15 wherein said focus corrector includes an optical convolving lens element disposed between a focal plane of the camera and a lens of the camera and a processor deconvolving the image.

18. A system in accordance with claim 8, further comprising a focus corrector correcting focus distortion in the images received by the camera.

19. A system in accordance with claim 18 wherein said focus corrector includes an optical path component.

20. A system in accordance with claim 18 wherein said focus corrector includes an optical convolving lens element disposed between a focal plane of the camera and a lens of the camera and a processor deconvolving the image.

21. A method for positioning a component at a selected location on a substrate, comprising:
picking-up the component with a pick-up head carried by a placement machine;
extending a retractable mirror carried with the pick-up head;
imaging the bottom of the component via the mirror;
retracting the mirror; and
imaging the substrate.

22. A method in accordance with claim 21, further comprising:
calculating an offset vector from said images of the bottom of the component and of the substrate.

23. A method in accordance with claim 22, further comprising:
repositioning the pick-up head in accordance with said offset vector.

24. A method in accordance with claim 23, further comprising:
iterating said calculating and said repositioning until the pick-up head is within a predetermined distance, excluding any vertical distance, of the selected location.

25. A method in accordance with claim 24, further comprising:
moving said pick-up head in a vertical direction to bring the component into contact with the substrate.
